(19) United States
(12) Patent Application Publication
(10) Pub. No.: US 2003/0204362 A1
(43) Pub. Date: Oct. 30, 2003

(54) Electronic vehicle log

(76) Inventors: Leigh-Anne Beresford, Brisbane (AU); Robert Dew, Brisbane (AU)

Correspondence Address: Barry E. Bretschneider, Morrison & Foerster LLP, Suite 5500, 2000 Pennsylvania Avenue, N.W., Washington, DC, 20006-1888, US

(21) Appl. No.: 10/128,518

(22) Filed: Apr. 24, 2002

(51) Int. Cl. G01P 11/00

(52) U.S. Cl. 702/149

(57) ABSTRACT

The device includes means to record verbal data from a vehicle user and combine it with information from an odometer to produce a log report. The report may include date, time, and commencing and terminating odometer readings The device further includes a user identifying capability. This capability may be allied with security means to prevent use of the vehicle unless pre-selected conditions are met including identification of the user and purpose of the journey.

### FIELD OF THE INVENTION

THIS INVENTION relates to devices for recording the distance and purpose of a motor vehicle journey. In particular, it relates to such a device that is responsive to the voice of the driver of a vehicle and identifies the driver of the vehicle.

### BACKGROUND ART

Basic information relating to the distance a vehicle travels is easily obtained by reference to the standard vehicle odometer. However, recording such information involves the inconvenience of manually writing data down.

On occasion, it is desirable to record both the purpose of a trip and the distance travelled. In a commercial situation, this may be considered of particular advantage for purposes such as monitoring the activities of employees who travel by vehicle as part of their duties.

The need to record the purpose and distance of journeys has been emphasised in jurisdictions with fringe benefit tax or similar legislation. In these circumstances, the ability to reliably distinguish between personal and business use may have significant economic advantages. The statutes in these jurisdictions often require provision of accurate travel information, including initial and terminal odometer readings for trips completed by a vehicle.

Various devices have been developed for recording distance travelled and the purpose of a journey. International Publication No WO 9713208 discloses an electronic vehicle location recorder. This device records date, time and location of a vehicle. This information, however, is required primarily for security purposes, particularly relating to commercial vehicles so as to ascertain and confirm the location and time of a vehicle's position.

German Patent No DE 4129148 describes an electronic log book for storing data relating to journeys for private or official use. The system receives input from the vehicle tachometer and start and end journey details are processed by a built-in central processing unit. However, the purpose of a journey is input manually via a front panel knob although audio and visual indicators may provide a reminder at the start of the journey to indicate vehicle use. The system, therefore, relies on a driver or other operator interrupting the normal process of commencing a journey and manually activating the device.

U.S. Pat. No. 5,046,007 is directed to a device for collecting travel-related data for a motor vehicle. This data includes information such as start time and date of a trip, a beginning odometer reading and a category code to indicate the purpose of the trip. Data collection is initiated by activation of the ignition switch of a vehicle. This invention, however, requires manual input of data via at least one keypad.

Japanese Patent No JP 11007471 outlines an apparatus for automatic service report production in commercial vehicles, such as taxis. A service report is generated based on an audio input unit, an engine speed sensor and a counter.

There is a need for a device that produces a vehicle use report including information provided verbally by an operator. This information should preferably include commencing and finishing odometer readings. It would be advantageous to also differentiate different users and prevent unauthorised use of the vehicle.

In addition, it would be of use if a user was compelled to activate the device prior to commencing a journey.

### OBJECT OF THE INVENTION

It is an object of the present invention to overcome or ameliorate at least one of the deficiencies of the prior art.

### SUMMARY OF THE INVENTION

In one form, although it need not be the only or indeed the broadest form, the invention resides in an electronic vehicle log for recording information relating to vehicular travel, said electronic vehicle log comprising:

voice interface means for capturing vocal input from a user of a vehicle;

odometer interface means for establishing odometer readings of the vehicle;

processing means for processing information from the voice interface means and odometer interface means;

storage means for storing data; and

communication means for reporting said data.

The voice interface means is suitably a microphone The voice interface means may further comprise an analog to digital converter. The voice interface means may also comprise a voice to text converter.

The odometer interface means is preferably in signal connection with a digital odometer of the vehicle. Alternatively, the odometer interface means may be a revolution monitor for monitoring the revolutions of a rotatable vehicle member. Preferably, the rotatable vehicle member is a drive shaft of the vehicle.

The processing means is preferably a central processing unit. The processing means may be programmed to analyse information from the odometer interface means, at least in part, according to the algorithm:

D=Ot−Oi

where D=distance travelled, Ot=terminal odometer reading, Oi=initial odometer reading.

Preferably, the communication means is an inlet/outlet port in signal connection with the processing means.

The electronic vehicle log may further comprise audio broadcast means. The audio broadcast means is suitably a speaker.

The electronic vehicle log may further comprise Random Access Memory means.

Preferably, the processing means includes time and date monitoring means. Preferably, the time and date monitoring means is an internal clock.

The processing means may further include interval checking means. The interval checking means is suitably programmed to monitor the interval from a prior downloading of data.

The electronic vehicle log may further comprise an activation means. The activation means may be an ignition interface wherein closing of an ignition circuit of the vehicle activates the electronic vehicle log. Opening of the ignition circuit may cause deactivation of the electronic vehicle log.

The electronic vehicle log may further comprise security means for preventing engine ignition other than in preselected conditions. The preselected conditions may include one or both of confirmation of a user's identity or confirmation of a purpose of a trip. Confirmation of a user's identity may be by use of an alpha numeric code. The alpha numeric code may be entered by use of a key pad. Alternatively, confirmation of a user's identity may be by voice recognition. Further alternatively, confirmation of a user's identity may be through use of a finger print scanner. In a further embodiment, the security means may include an electronic identification card.

The electronic vehicle log may further comprise safety override means for overriding the security means. The safety override means may suitably be a lock and key. The lock and key may be electronic. The key may be in the form of an electronic key pad requiring the entering of a code or personal identification number.

The electronic vehicle log may further comprise position identifying means. The position identifying means may be a global positioning system (“GPS”) device. The GPS device may provide information to the processing means.

### BRIEF DESCRIPTION OF THE DRAWINGS

FIG. 1 is a schematic representation of an embodiment of an Electronic Vehicle Log;

FIG. 2 is a schematic representation of a further embodiment of an Electronic Vehicle Log;

FIG. 3 is a general flowchart of the procedure performed by the Electronic Vehicle Log of FIG. 1 or FIG. 2;

FIG. 4 is a flowchart of the security procedure of the Electronic Vehicle Log.

FIG. 5 is a flowchart of the initialisation procedure of the Electronic Vehicle Log.

FIG. 6 is a flowchart of the turn-on procedure of the Electronic Vehicle Log.

FIG. 7 is flowchart of the journey storage procedure of the apparatus.

FIG. 8 is a flowchart of the turn-off procedure of the Electronic Vehicle Log.

FIG. 9 is a flowchart of the check date procedure of the Electronic Vehicle Log.

FIG. 10 is a block diagram overview of the process performed by the apparatus.

FIG. 11 shows a computer screen display of an EVL record.

### DETAILED DESCRIPTION OF THE DRAWINGS

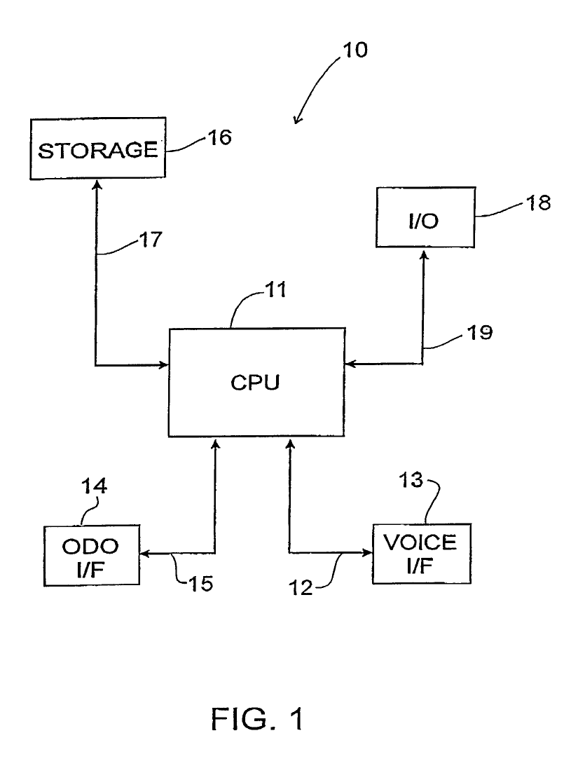

In FIG. 1, an electronic vehicle log (“EVL”) 10 is shown comprising processing means in the form of a central processing unit (“CPU”) 11. The CPU 11 is in signal connection via data bus 12 with voice interface means 13 for capturing vocal input from a user. An odometer interface means 14 is in signal connection with the CPU 11 via data bus 15. The EVL 10 also has storage means 16 for storing information, which is in signal connection with the CPU 11 via data bus 17.

The EVL 10 also has inlet/outlet port 18 in signal connection via data bus 19 with CPU 11 and storage means 16 for uploading and downloading information to or from an external source.

In use, a vehicle occupant records the purpose of a trip through the voice interface means 13 which is in signal connection with the processing means. After processing, data relating to the purpose is stored in the storage means 16 for subsequent access, when required.

Prior to commencement of movement of the vehicle, a journey commencement odometer reading is taken and stored. This reading may simply be retained from a reading taken at the termination of a journey immediately preceding the journey for which details are to be recorded.

At the end of a journey, the EVL 10 takes a termination odometer reading and stores this data as well. The distance travelled is calculated by the processing means according to the algorithm:

D=Ot−Oi

where D=distance travelled, Ot=termination odometer reading, and Oi=initial odometer reading.

The distance travelled and purpose of the trip are both stored in the storage means 16 for subsequent access and use.

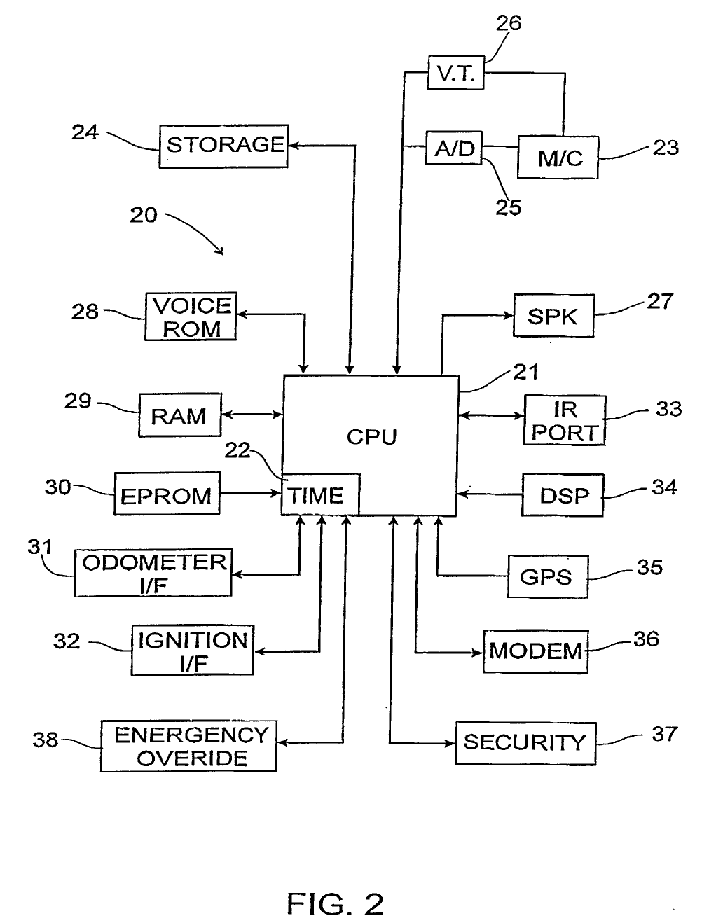

FIG. 2 is a more detailed schematic representation of a preferred embodiment of the invention. An EVL 20 is shown consisting of processing means in the form of central processing unit 21 which includes time and date monitoring capacity in the form of internal clock 22.

A microphone 23 is provided for receiving vocal input from a vehicle user, preferably the driver although clearly another occupant may be considered the user. The microphone 23 is in signal connection with an interface which is, in turn, in signal connection with the CPU 21 wherein spoken information is processed and ultimately stored in the storage means 24. The EVL 20 may include at least one analogue to digital converter 25 for converting analogue signals (for example from the microphone) to digital signals for processing or storage. Further a voice to text converter 26 may also be included in the device for direct conversion of spoken words to printed text.

A speaker 27 provides the EVL 20 with the capacity to generate and broadcast audio cues for a driver. These cues may be in the form of an audible tone or may be spoken instructions recorded on voice ROM means 28. The cues may direct compliance with steps in recording the purpose of a trip.

The EVL 20 includes Random Access Memory (“RAM”) 29 for assisting in function of the EVL 20 by providing variable temporary storage capacity for data and interaction with the CPU 21.

The EVL 20 further includes Erasable, Programmable, Read Only Memory (“EPROM”) 30 for storage of instructions which may be altered if required.

Odometer interface means 31 is provided which, in its simplest form, may be an interface with a digital odometer of a vehicle for monitoring the reading of that odometer. The odometer interface means may function by monitoring electronic pulses which are used by digital odometers in most modern vehicles. Alternatively, the odometer interface may be based on a component of the vehicle, such as a rotating drive shaft. The drive shaft may include magnets rotating in a coil to produce alternating current. The frequency of the alternating current may be analysed to indicate number of rotations of the drive shaft and, thereby, distance travelled. An odometer reading may be produced in the EVL which mirrors that of the vehicle odometer.

Calibration may occur in a pre-use initialisation procedure during which a known distance is travelled and the number of revolutions of the drive shaft calculated. Analysis of the results may be made according to the algorithm:

$$a = \frac{R}{S}$$

where a=revolutions per kilometre, R=total revolutions of the journey, and S=distance travelled in kilometres.

An initial odometer reading is entered into the EVL and subsequent odometer readings are calculated by the EVL which is programmed to form a calculation according to the algorithm:

$$Ot = Oi + \frac{Ry}{a}$$

where Ot=terminal odometer reading in kilometres, Oi=initial odometer reading in kilometres, Rt=number of revolutions during a journey, and a=revolutions per kilometre. Alternatively the constant “a” may be calculated for fractions of a kilometre or for miles if more convenient. Alternatively, a similar procedure may be followed in relation to the electronic pulses of a digital odometer to ensure the EVL is accurately calibrated to record odometer readings and distances travelled.

While the internal clock 22 is constantly provided with a power supply, the rest of the EVL may be triggered by an initiating event and rely on power from the battery of a vehicle. In FIG. 2, the initiating event is closure of the ignition circuit which impacts on the device through ignition interface 32 Likewise, shutdown of the apparatus is triggered by the ignition circuit being opened or switched off. This acts as a signal for the apparatus to record the terminal odometer reading.

The EVL may also record a time and date reading simultaneously with ignition activation and deactivation.

An IR port 33 provides an input/output capacity for the EVL 20 which permits installation of information and alteration of programming, if required. It also allows downloading of information from storage 24 to an external receiving unit, such as a microcomputer.

A Digital Signal Processor (“DSP”) 34 enhances the function of the EVL by controlling digital signals and providing some processing of those signals.

The EVL 20 in FIG. 2 also includes a Global Positioning Service module (“GPS”) 35 which can provide additional information in relation to accurate location. In one embodiment of the device, the GPS module 35 is used to confirm distance travelled or, alternatively, it may be used as the primary or only means of determining distance travelled by a vehicle.

A modem 36 is also included to allow communication by a mobile telephone to permit transfer of information to and from a receiving device remote to the vehicle.

The EVL 20 may also include security means 37 which may require confirmation of a driver's identity before permitting the vehicle to be driven. The security means may include a code recognition device requiring an alpha numeric code entered through a manual key pad. Alternatively, the security means may be in the form of a voice recognition system with a capacity to prevent ignition of the engine unless the appropriate person is confirmed as driver Identification may be via a finger print or thumb print scanner. Alternatively or additionally, a driver may use an electronic identification card, often referred to as a “swipe” card, to identify herself or himself. Obviously, identification also enables individual records to be compiled for a range of different drivers. This is of particular advantage as it facilitates the allotment of distance travelled to individual users in multi-user vehicles. An overview of individual activities is then possible. This advantage may exist in tandem with immobilisation of the vehicle until the EVL is activated by an approved user.

Emergency override means 38 is provided in the event that an authorised user is incapable of activating the EVL and therefore the vehicle or in the event of a malfunction of the EVL 20. This override means may be in the form of a key activated isolation switch to quarantine the EVL from the operation of the vehicle.

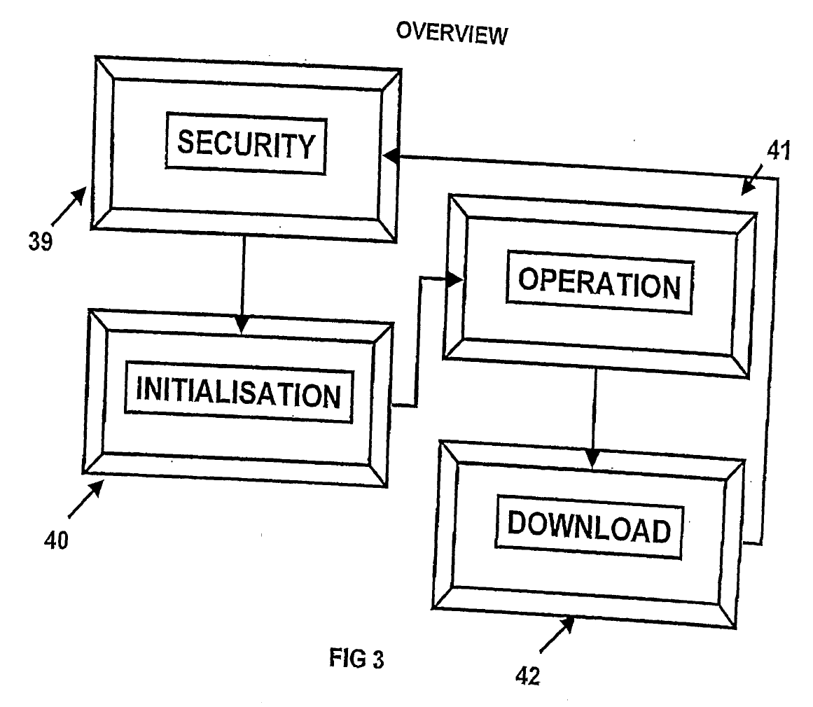

In FIG. 3 a flowchart discloses a general overview of the function of the EVL. A first security step 39 is taken by inserting pre-selected security parameters for identifying a user of a vehicle. The preferred parameter is use of a “swipe” card. Alternatively, a user might enter or recite a numeric code. However, other parameters may be used, such as voice recognition. After the security step 39 is performed, an initialisation step 40 is undergone in which the odometer reading of the EVL is synchronised with that of the vehicle in which it is located Additionally, a calculation may be made for the conversion factor between the pulses of a vehicle's digital odometer and distance travelled so that subsequent calculations of distance travelled by the EVL will be synchronised with the vehicle odometer. Alternatively or additionally, the conversion factor for drive shaft rotations may be calculated. The end point of the process is to synchronise EVL readings with those of the vehicle and, in turn, with distance travelled. The initialisation step may also include identification details for a vehicle and its drivers so that only pre-ordained drivers are entitled to pilot a specific vehicle.

The EVL is then used during standard vehicle operation 41 for a preselected interval, such as 12 weeks or for any other convenient interval. Information stored in the EVL as a result of vehicle operation 41 may be down loaded 42 to an external receiving source, such as a microcomputer. Alternatively, the information may be down loaded as a written report produced by the EVL itself. At the end of the download step 42, the EVL returns to the initial security step 39.

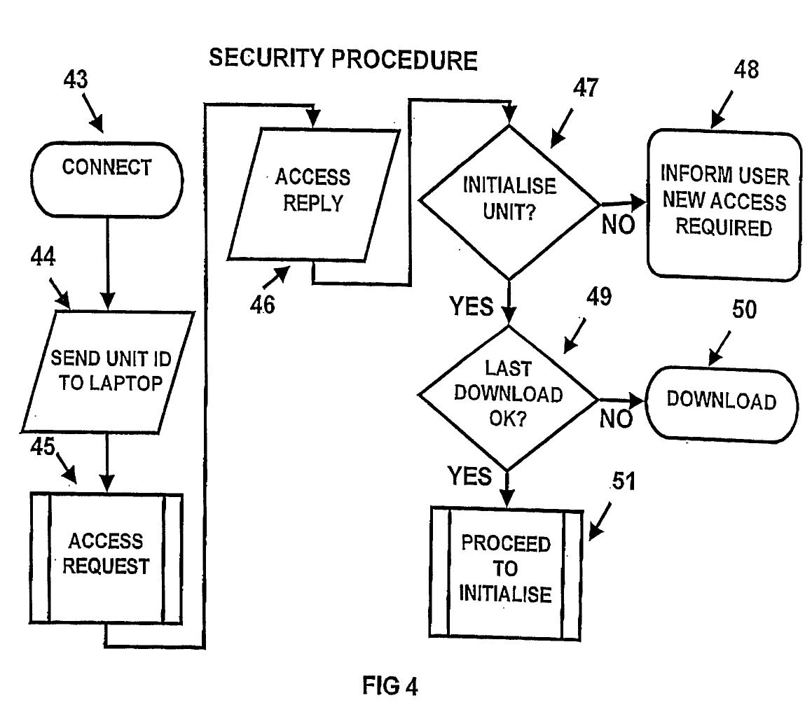

FIG. 4 is a flow diagram for the security procedure of FIG. 3. After initial connection 43, a unit identification is sent to a laptop computer or similar 44 and access request prompt 45 is provided by the EVL. A user provides access reply 46. A check is made on whether the unit is currently initialised 47. If not, a user is informed that new access is required 48. Alternatively, if the EVL is currently initialised, EVL checks that the last download of information was satisfactory 49. If not, download of the information 50 is prompted. Once the download is effected or, in the event it is not required, the EVL proceeds to the initialising step 51.

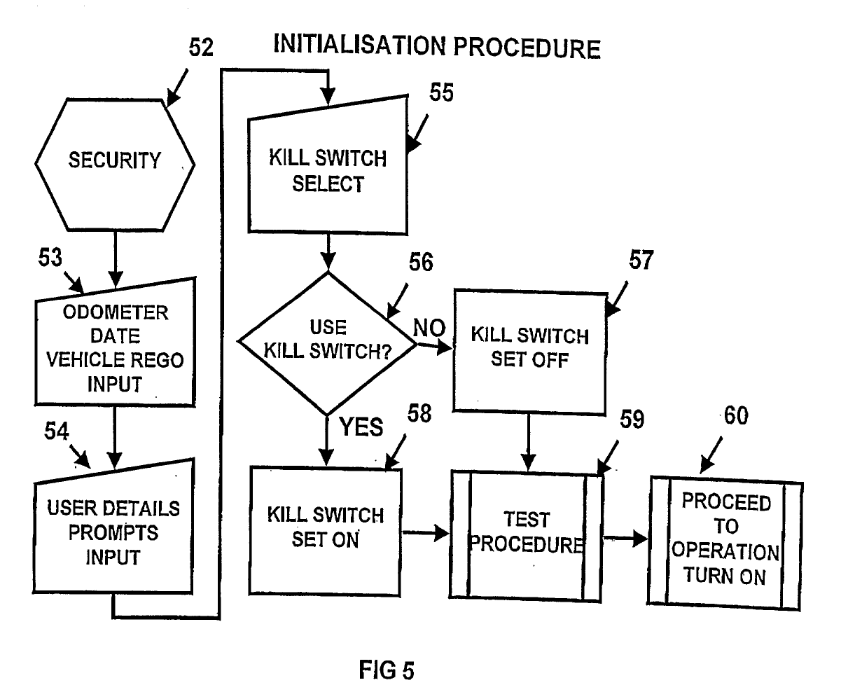

After completion of the steps in FIG. 4, the initialisation procedure is conducted as shown in the flowchart of FIG. 5. After the security procedure 52 as described in FIG. 4, the EVL records an odometer, date and vehicle registration input 53. User details are prompted 54 and then entered into the EVL.

The kill switch selection function 55 is then provided and a user may choose whether a kill switch should be set on or off 56. When set on, the kill switch provides security means which may require confirmation of a drivers identity before a vehicle may be driven This capacity may also be inactivated if preferred so that the security procedure is not required before use. Additionally or alternatively, the kill switch may be used to ensure recording of the purpose of a journey by mandating input of purpose before enabling use of the vehicle. The kill switch may be set off 57 or on 58. A test procedure for the kill switch is provided 59 after which the EVL is in readiness for turning on 60 for operation during travel.

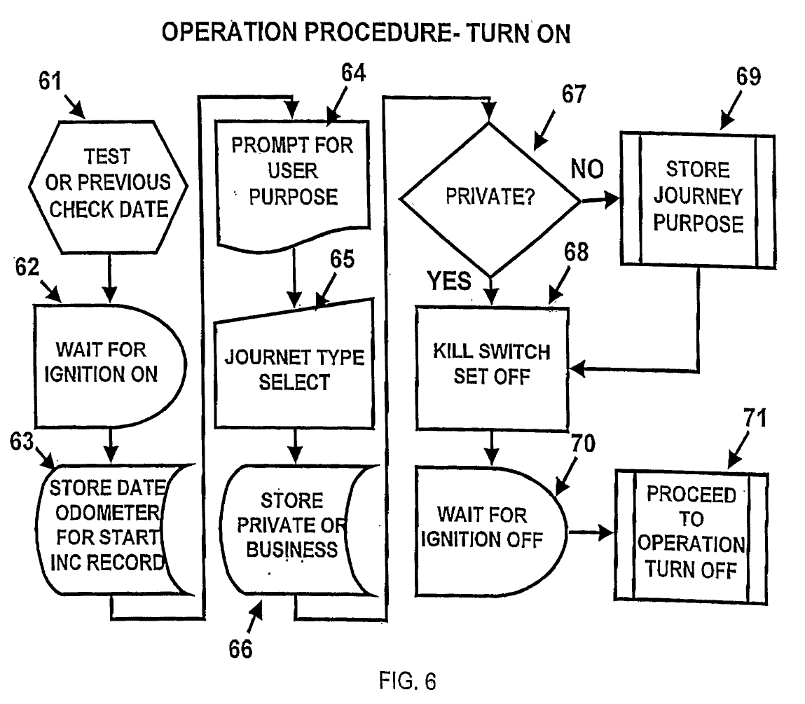

After completion of the steps in FIG. 5, the EVL is in readiness for commencement of the Turn On Procedure as shown in FIG. 6 After an initial test or reference to previous check date 61, the EVL waits for an ignition signal 62 at which time it stores date and odometer reading 63 for starting a record The EVL provides a prompt for a user to provide the journey type 64. This prompt may be audible or visual on an LED display. A driver then dictates the journey type 65. The EVL stores the type of the journey 66. If the type is private 67, the EVL sets the kill switch to the off position at 68 allowing the vehicle to be driven. If the type is business, a user must record the purpose 69 before the kill switch is released. The EVL is then in readiness to record parameters of interest while it awaits an ignition turn off 70. At that time the EVL proceeds to the turn off operation 71.

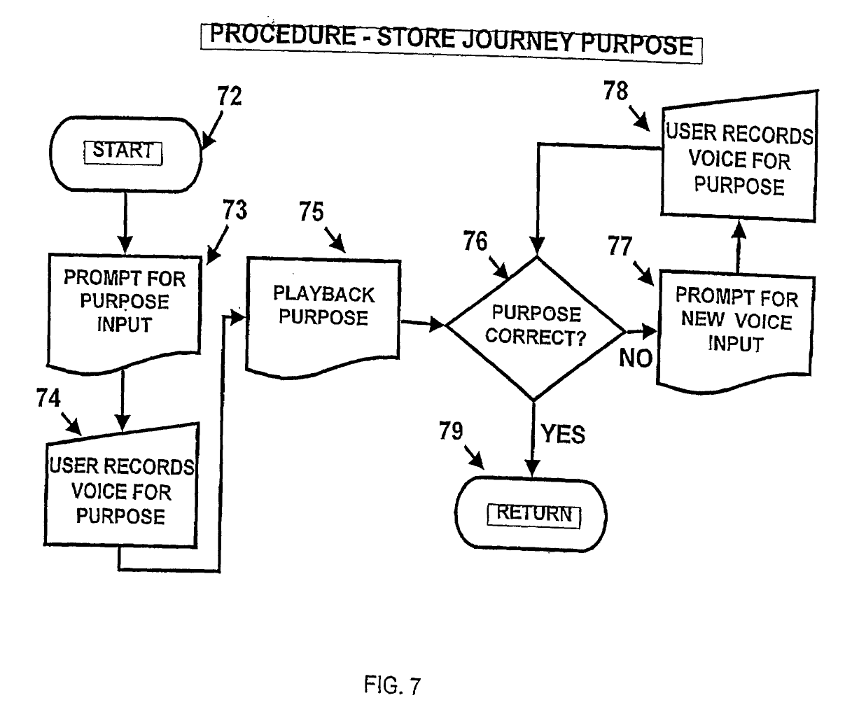

The process for storing the journey purpose is shown in the flowchart of FIG. 7. After the start 72 of the process, the EVL provides a prompt for the purpose of the journey input 73 The user records the purpose of the journey by use of his or her voice 74. The EVL plays back the purpose 75 for confirmation by the user 76. If the purpose is incorrect, a prompt is given for a new voice instruction 77 and the user records the purpose by voice at 78. Once the purpose is correct, the EVL returns to its further function 79.

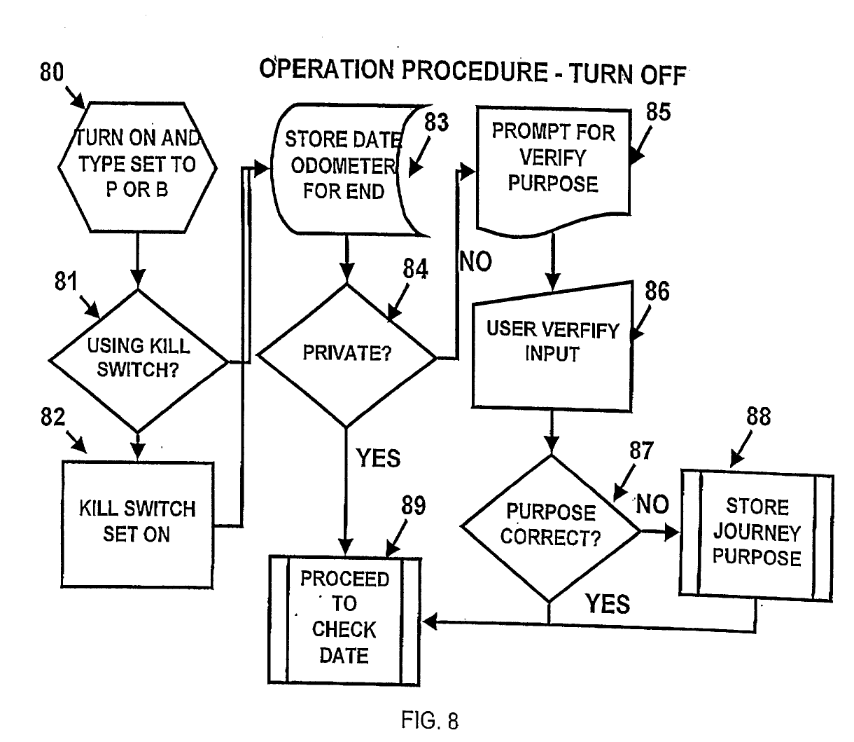

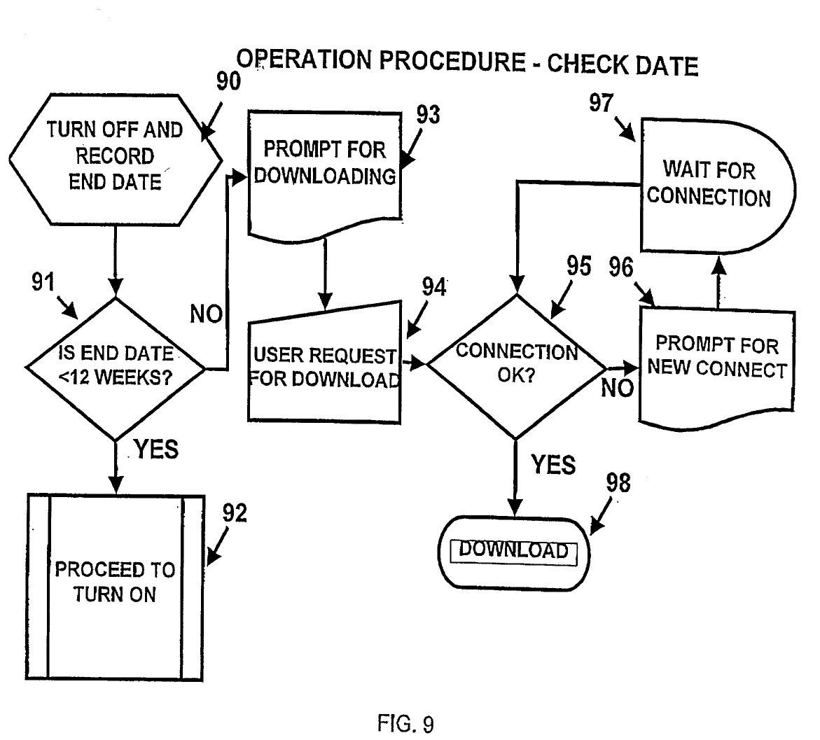

The EVL also includes a turn off operation procedure as shown in the flowchart of FIG. 8. After turn on, the type of the journey is set to private or business 80. If the Kill Switch 81 is in use it is set on 82. The EVL stores the date and the termination odometer reading 83. The EVL prompts a vocal response from the user with a question as to whether use of the vehicle was private 84. If the response is positive to the effect that use is private, the EVL proceeds to the check date function 89. If the response is negative, the EVL seeks verification of the recorded purpose of the journey 85. If the user verifies the purpose 86, the EVL notes the purpose as correct 87 and the EVL proceeds to the check date procedure 89. If the purpose was incorrectly noted 87 the EVL stores the correct purpose 88 and then proceeds to the check date procedure 89 which is better described in relation to FIG. 9.

At the Check Date Procedure 89 of FIG. 8, the EVL turn off procedure is completed and a record is made of the end date 90 of FIG. 9. The EVL reviews the end date 91 to confirm whether it is within or outside a set period, such as 12 weeks from the initialisation procedure. If the period is less than the selected period, the EVL proceeds to the Turn On Procedure 92. Alternatively, if the period is the predetermined period or longer, a prompt is provided to promote downloading 93. The user then requests downloading of data from the EVL 94 and connects the EVL to the downloading receiving unit, such as a microcomputer. A connection check is made at 95. If the connection is inadequate, a prompt is provided at 96 to reconnect and a waiting period 97 occurs while reconnection is effected. Once connection is satisfactory, downloading of the data from the EVL occurs 98.

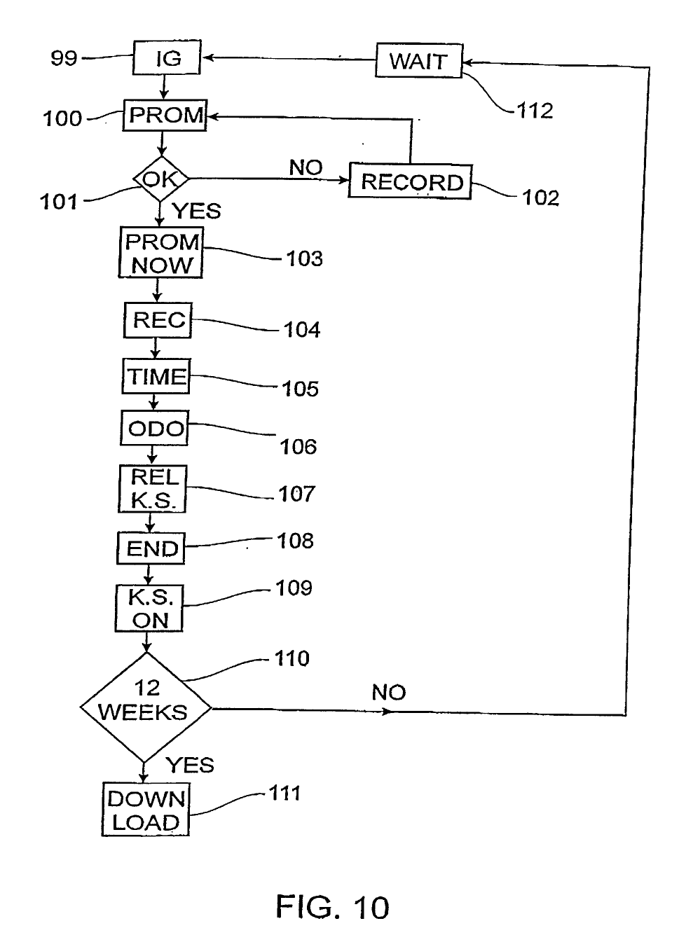

FIG. 10 is a further overview flowchart of the operation of the EVL. A commencing event 99, such as closing the vehicle ignition circuit occurs. A prompt is provided 100 to confirm the purpose of the last journey. If confirmation occurs 101, the EVL continues on the operation pathway. If confirmation is not confirmed 101, the EVL requests recordal of the purpose 102 and returns to the request for confirmation of the purpose of the preceding journey. The EVL then prompts the driver to record the purpose of the present journey 103 and the driver meets that requirement by speaking the purpose which is recorded 104. On receipt of the instructions as to the purpose of the journey, the EVL records the time 105 and odometer reading 106. The EVL also releases the security kill switch for the vehicle allowing engine ignition and movement of the vehicle 107. At the end of the journey 108, the EVL once again records the odometer and time and activates the security kill switch 109.

The EVL also calculates the period of time since the last download of information from its memory. If it is greater than a predetermined time, such as 12 weeks, 110 a prompt is given to promote download 111. If the time period is less than 12 weeks, the EVL returns to the status awaiting ignition event 112.

A certain time period may be allowed between the end event 108 and the turn off operation. For example, a period of 15 minutes may be dictated so that minor interruptions to a journey, such as fuel replenishment or purchase of goods does not interrupt the recording of a single journey. In this case, a vocal command may be available to reset the EVL if, in fact, the short interval actually represents the termination of purpose of a specific trip.

As shown in FIG. 10, specific recording intervals are usually required. The EVL has a time limit specified which, in FIG. 10, is 12 weeks. At this time, a driver will be prompted to generate a report or transfer data to an external store.

The EVL may be programmed to automatically recommence a recording period at the end of the specified time. Additionally, the device may have an accumulated period of use programmed into it so that, in the case of licenced use of the device, the licenced period may be set to automatically inactivate the device at the expiry of such period.

The EVL may further include an LCD or other display (not shown) for providing prompts or displaying data of interest. For example, the LCD display may show the odometer reading as calculated by the device so that it can be checked to coincide with the vehicle odometer.

The EVL may also be programmed to record details, such as car registration number and other work-related expenses, such as meals and fuel.

The EVL provides at least two distinct advantages over prior art devices. A driver is not required to manually input any information relating to purpose but rather simply uses vocal instructions to record the purpose of a journey. Because such a process is simpler and more convenient, there will be greater compliance with the procedure leading to more accurate recording of information with flow-on benefits to subsequent reports generated from the data. Additionally, as result of vocal input, both purpose and actual odometer readings are recorded. The latter step is necessary to satisfy statutory reporting requirements in the revenue law of some countries.

In addition, the individual identification of a user provides distinct administrative and security advantages. An employer may ensure compliance with statutory requirements of national taxation legislation and fuel subsidy provisions. Further, an individual's work performance may be closely monitored. The security means provides an extra level of anti-theft protection for a vehicle as well as making compliance with recording requirements compulsory.

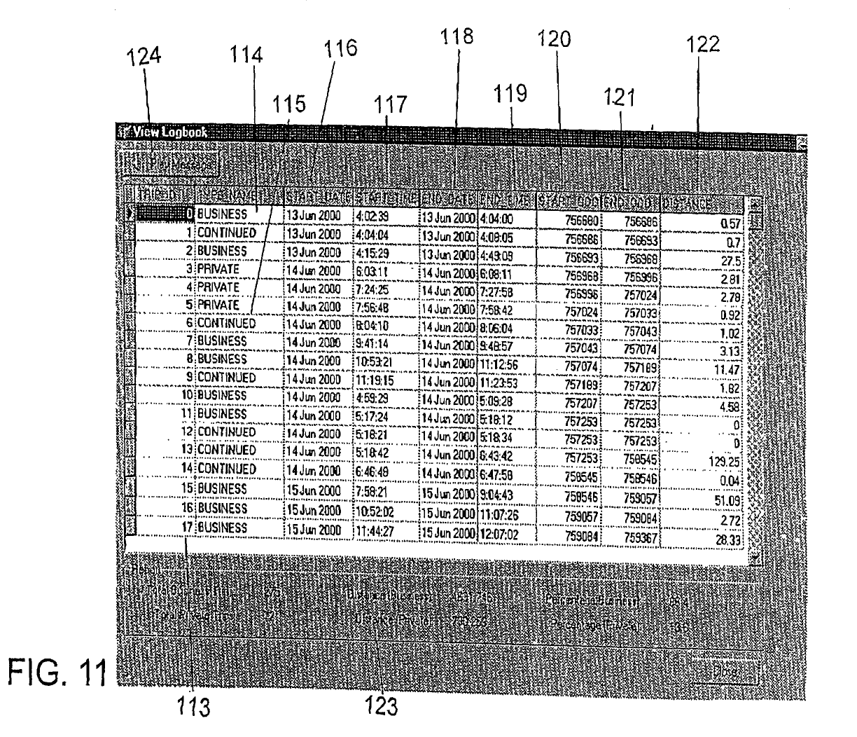

FIG. 11 shows a computer screen display of an EVL record.

Trips may be allotted individual numbers 113. The purpose of a trip may be shown next to a number 114 and some of those purposes may be shown as continuations 115. That is, although broken into components, the overall combination of distances travelled was for one purpose. The start date is recorded 116 as the start time 117 and the finish date 118 and finish time 119. The starting odometer 120 and finishing odometer 121 readings are also taken and distance travelled 122 is calculated. An overview report 123 may be displayed. In addition, the recorded messages relating to an individual trip may be replayed by highlighting a trip and activating the play message button 124.

Throughout the specification, the aim has been to describe the preferred embodiments of the invention without limiting the invention to any one embodiment or specific collection of features. Various changes and modifications may be made to the embodiments described and illustrated without departing from the present invention.

The claims defining the invention are as follows:

1. An electronic vehicle log comprising:
voice interface means for capturing vocal input;
odometer interface means for determining odometer readings for a vehicle;
processing means for processing input from the voice interface means and odometer interface means;
storage means for storing data; and
communication means for reporting the data.

2. The electronic vehicle log of claim 1, wherein the voice interface means comprises a microphone and analog to digital converter.

3. The electronic vehicle log of claim 2 further comprising a voice to text converter.

4. The electronic vehicle log of claim 1, wherein the odometer interface means is in signal connection with a digital odometer of the vehicle.

5. The electronic vehicle log of claim 1, wherein the odometer interface means includes a revolution monitor for monitoring the revolutions of a drive shaft of the vehicle.

6. The electronic vehicle of claim 1, wherein the processing means is a central processing unit.

7. The electronic vehicle of claim 6, wherein the central processing unit is programmed to analyse input from the odometer interface means according to the algorithm:
D=Ot−Oi
where D=distance travelled, Ot=terminal odometer reading, and Oi=initial odometer reading.

8. The electronic vehicle log of claim 1 further comprising an audio speaker for providing audible cues to a user.

9. The electronic vehicle log of claim 1, wherein the processing means includes an internal clock, for time and date monitoring.

10. The electronic vehicle log of claim 1 further including an ignition interface for activating the electronic vehicle log.

11. The electronic vehicle log of any one of claims 1 to 10 further comprising user identification means.

12. The electronic vehicle log of claim 11, wherein the user identification means comprises an electronic identifier and reader.

13. The electronic vehicle log of claim 11, wherein the electronic identifier is an electronic identifying card.

14. The electronic vehicle log of claim 11, wherein the user identification means comprises a key pad for receiving an identifying code.

15. The electronic vehicle log of claim 11, wherein the user identification means includes voice recognition means.

16. The electronic vehicle log of any one of the preceding claims further comprising security means for preventing engine ignition unless at least one pre-selected condition is met.

17. The electronic vehicle log of claim 16, wherein a pre-selected condition is identification of a user.

18. The electronic vehicle log of claim 16, wherein a pre-selected condition is identification of a purpose for a trip.

19. The electronic vehicle log of claim 16 further comprising safety override means for overriding the security means.

20. The electronic vehicle log of any one of the preceding claims further comprising position identifying means.

21. The electronic vehicle log of claim 20, wherein the position identifying means is a Global Positioning System device.

22. An electronic vehicle log substantially as described herein with reference to the accompanying figures.
DATED this Sixteenth day of October 2000.
